(19) United States
(12) Patent Application Publication
(10) Pub. No.: US 2025/0081027 A1
(43) Pub. Date: Mar. 6, 2025

(54) SYSTEMS AND METHODS FOR SHARING QUALITY OF SERVICE (QOS) CHARACTERISTICS

(71) Applicant: Meta Platforms Technologies, LLC, Menlo Park, CA (US)

(72) Inventors: Muhammad Kumail Haider, Sunnyvale, CA (US); Guoqing Li, Cupertino, CA (US)

(73) Assignee: Meta Platforms Technologies, LLC, Menlo Park, CA (US)

(21) Appl. No.: 18/796,686

(22) Filed: Aug. 7, 2024

Related U.S. Application Data
(60) Provisional application No. 63/580,867, filed on Sep. 6, 2023.

(51) Int. Cl. H04W 28/02; H04W 48/20

(52) U.S. Cl. CPC H04W 28/0268; H04W 48/20

(57) ABSTRACT

Systems, methods, and devices for sharing quality of service (QoS) characteristics may include a first access point (AP) which generates an information element indicating QoS characteristics of a service set (ss) for the first AP. The first AP may transmit the information element to a second AP.

### CROSS-REFERENCE TO RELATED APPLICATIONS

This application claims the benefit of and priority to U.S. Provisional Application No. 63/580,867, filed Sep. 6, 2023, the contents of which is incorporated herein by reference in their entirety.

### FIELD OF DISCLOSURE

The present disclosure is generally related to communications, including but not limited to systems and methods for sharing quality of service (QoS) characteristics.

### BACKGROUND

Devices can use various wireless communication mediums and protocols for exchanging information with various endpoints. For example, some devices may operate on a wireless local area network (WLAN), served by an access point (AP), to provide connectivity of such devices to various endpoints. Devices may have different quality of service (QoS) requirements, depending on—for example—an application which the device is supporting, a type of traffic, and so forth.

Artificial reality, such as a virtual reality (VR), augmented reality (AR), or mixed reality (MR), provides immersive experience to a user. In one example, a head wearable display (HWD) can display an image of a virtual object generated by a computing device communicatively coupled to the HWD, such as over a wireless network.

### SUMMARY

In one aspect, this disclosure is directed to a method. The method may include generating, by a first access point (AP), an information element indicating quality of service (QoS) characteristics of a service set (SS) for the first AP. The method may include transmitting, by the first AP, the information element to a second AWP.

In some embodiments, the information element includes a control information field including a first subfield indicating a direction of the information element, where the first subfield is set to indicate that the information element is carrying the QoS characteristics of/for the SS. In some embodiments, the control information field further includes a second subfield identifying at least one of a link identifier or a bandwidth. In some embodiments, the second subfield identifies the link identifier when the first subfield is set to a first value, and the second subfield identifies the bandwidth when the first subfield is set to a value other than the first value. In some embodiments, the QoS characteristics indicate traffic characteristics during respective service intervals identified in the information element. In some embodiments, the QoS characteristics include a minimum service interval, a maximum service interval, a delay bound, a service start time, and a medium time.

In some embodiments, the information element further includes a field indicating an identifier for the service set and a schedule identifier. In some embodiments, the information element comprises a first information element. The method may include receiving, by the first AP from the second AP, a second information element indicating QoS characteristics of a second SS for the second AP. In some embodiments, the method includes establishing, by the first AP with the second AP, a coordinated target wake time (TWT) schedule according to the first information element and the second information element. In some embodiments, the information element is carried in at least one of a management or action frame, a spatial consistency sounding (SCS) request frame, an SCS response frame, or an individually addressed frame.

In another aspect, this disclosure is directed to a first access point (AP) including a transceiver, and one or more processors configured to generate an information element indicating quality of service (QoS) characteristics of a service set (SS) for the first AP, and transmit, via the transceiver, the information element to a second AP.

In some embodiments, the information element includes a control information field including a first subfield indicating a direction of the information element, where the first subfield is set to indicate that the information element is carrying the QoS characteristics of/for the SS. In some embodiments, the control information field further includes a second subfield identifying at least one of a link identifier or a bandwidth. The second subfield may identify the link identifier when the first subfield is set to a first value, and can identify the bandwidth when the first subfield is set to a value other than the first value. In some embodiments, the QoS characteristics indicate traffic characteristics during respective service intervals identified in the information element.

In some embodiments, the QoS characteristics comprise a minimum service interval, a maximum service interval, a delay bound, a service start time, and a medium time. In some embodiments, the information element further includes a field indicating an identifier for the service set and a schedule identifier. In some embodiments, the information element includes a first information element. The one or more processors may be configured to receive, via the transceiver from the second AP, a second information element indicating QoS characteristics of a second SS for the second AP, and establish, with the second AP, a coordinated target wake time (TWT) schedule according to the first information element and the second information element. In some embodiments, the information element is carried in at least one of a management or action frame, a spatial consistency sounding (SCS) request frame, an SCS response frame, or an individually addressed frame. In some embodiments, the first AP comprises at least one of a hardware AP, a soft AP, or a peer-to-peer station (STA).

In yet another aspect, this disclosure is directed to a non-transitory computer readable medium storing instructions that, when executed by one or more processors of a first access point (AP), cause the one or more processors to generate an information element indicating quality of service (QoS) characteristics of a service set (SS) for the first AP, and transmit, via a transceiver, the information element to a second AP.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a timing diagram showing a wake-up/sleep schedule of a computing device utilizing TWT, according to an example implementation of the present disclosure.

FIG. 5 is a block diagram of a system for sharing quality of service (QoS) characteristics, according to an example implementation of the present disclosure.

FIG. 6 is an example format of various control information fields of an information element that may be used identify QoS information, according to an example implementation of the present disclosure.

FIG. 7 is an example format of various characteristics information fields of the information element of FIG. 6, according to an example implementation of the present disclosure.

FIG. 8 and FIG. 9 are example formats of a spatial consistency sounding (SCS) request and response frame, respectively, which can include QoS information, according to an example implementation of the present disclosure.

FIG. 10 is an example format of an individually addressed frame which can include QoS information, according to an example implementation of the present disclosure.

FIG. 11 is a flowchart showing an example method of sharing quality of service (QoS) characteristics, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

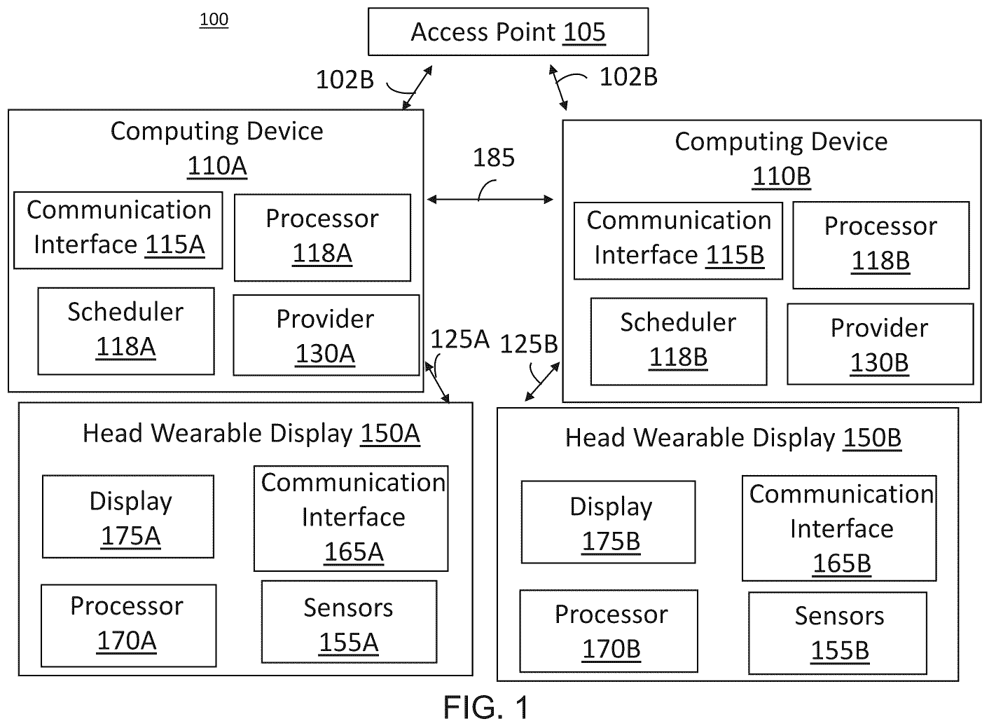

FIG. 1 is a block diagram of an example artificial reality system environment. FIG. 1 provides an example environment in which devices may communicate traffic streams with different latency sensitivities/requirements. In some embodiments, the artificial reality system environment 100 includes an access point (AP) 105, one or more head wearable displays (HWD) 150 (e.g., HWD 150A, 150B) worn by a user, and one or more computing devices 110 (computing devices 110A, 110B) providing content of artificial reality to the HWDs 150.

The access point 105 may be a router or any network device allowing one or more computing devices 110 and/or one or more HWDs 150 to access a network (e.g., the Internet). The access point 105 may be replaced by any communication device (cell site). A HWD may be referred to as, include, or be part of a head mounted display (HMD), head mounted device (HMD), head wearable device (HWD), head worn display (HWD), or head worn device (HWD). In one aspect, the HWD 150 may include various sensors to detect a location, an orientation, and/or a gaze direction of the user wearing the HWD 150, and provide the detected location, orientation and/or gaze direction to the computing device 110 through a wired or wireless connection. The HWD 150 may also identify objects (e.g., body, hand face).

In some embodiments, the computing devices 110A, 110B communicate with the access point 105 through communication links 102A, 102B (e.g., interlinks), respectively. In some embodiments, the computing device 110A may communicate with the HWD 150A through a communication link 125A (e.g., intralink), and the computing device 110B may communicate with the HWD 150B through a wireless link 125B (e.g., intralink).

The computing device 110 may be a computing device or a mobile device that can retrieve content from the access point 105, and can provide image data of artificial reality to a corresponding HWD 150. Each HWD 150 may present the image of the artificial reality to a user according to the image data.

The computing device 110 may determine a view within the space of the artificial reality corresponding to the detected location, orientation and/or the gaze direction, and generate an image depicting the determined view detected by the HWD 150s. The computing device 110 may also receive one or more user inputs and modify the image according to the user inputs. The computing device 110 may provide the image to the HWD 150 for rendering. The image of the space of the artificial reality corresponding to the user's view can be presented to the user.

In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the computing device 110 may be performed by the HWD 150, and/or some of the functionality of the HWD 150 may be performed by the computing device 110. In some embodiments, the computing device 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155 (e.g., sensors 155A, 155B) including eye trackers and hand trackers for instance, a communication interface 165 (e.g., communication interface 165A, 165B), an electronic display 175, and a processor 170 (e.g., processor 170A, 170B). These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, hand trackers, eye trackers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors 155 may also include eye trackers with electronic components or a combination of electronic components and software components that determine a gaze direction of the user of the HWD 150. In other embodiments, the eye trackers may be a component separate from sensors 155. In some embodiments, the HWD 150, the computing device 110 or a combination may incorporate the gaze direction of the user of the HWD 150 to generate image data for artificial reality. In some embodiments, the eye trackers (as part of the sensors 155, for instance) include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers as part of the sensors 155. In some embodiments, a user of the HWD 150 is prompted to enable or disable the eye trackers as part of the sensor 155 configuration.

In some embodiments, the sensors 155 include the hand tracker, which includes an electronic component or a combination of an electronic component and a software component that tracks a hand of the user. In other embodiments, the hand tracker may be a component separate from sensors 155. In some embodiments, the hand tracker includes or is coupled to an imaging sensor (e.g., camera) and an image processor that can detect a shape, a location and/or an orientation of the hand. The hand tracker may generate hand tracking measurements indicating the detected shape, location and/or orientation of the hand.

In some embodiments, the communication interfaces 165 (e.g., communication interface 165A, 165B) of the corresponding HWDs 150 (e.g., HWD 150A, 150B) and/or communication interfaces 115 (e.g., communication interface 115A, 115B) of the corresponding computing devices (e.g., computing device 110A, 110B) include an electronic component or a combination of an electronic component and a software component that is used for communication.

The communication interface 165 may communicate with a communication interface 115 of the computing device 110 through an intralink communication link 125 (e.g., communication link 125A, 125B). The communication interface 165 may transmit to the computing device 110 sensor measurements indicating the determined location of the HWD 150, orientation of the HWD 150, the determined gaze direction of the user, and/or hand tracking measurements. For example, the computing device 110 may receive sensor measurements indicating location and the gaze direction of the user of the HWD 150 and/or hand tracking measurements and provide the image data to the HWD 150 for presentation of the artificial reality, for example, through the wireless link 125 (e.g., intralink). For example, the communication interface 115 may transmit to the HWD 150 data describing an image to be rendered. The communication interface 165 may receive from the computing device 110 sensor measurements indicating or corresponding to an image to be rendered. In some embodiments, the HWD 150 may communicate with the access point 105.

Similarly, the communication interface 115 (e.g., communication interface 115A, 115B) of the computing devices 110 may communicate with the access point 105 through a communication link 102 (e.g., communication link 102A, 102B). In certain embodiments, the computing device 110 may be considered a soft access point (e.g., a hotspot device). Through the communication link 102 (e.g., interlink), the communication interface 115 may transmit and receive from the access point 105 AR/VR content. The communication interface 115 of the computing device 110 may also communicate with communication interface 115 of a different computing device 110 through communication link 185. As described herein, the communication interface 115 may be a counterpart component to the communication interface 165 to communicate with a communication interface 115 of the computing device 110 through a communication link (e.g., USB cable, a wireless link).

The communication interfaces 115 and 165 may receive and/or transmit information indicating a communication link (e.g., channel, timing) between the devices (e.g., between the computing devices 110A and 110B across communication link 185, between the HWD 150A and computing device 110A across communication link 125). According to the information indicating the communication link, the devices may coordinate or schedule operations to avoid interference or collisions.

The communication link may be a wireless link, a wired link, or both. In some embodiments, the communication interface 165/115 includes or is embodied as a transceiver for transmitting and receiving data through a wireless link. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the computing device 110 and the head wearable display 150 are implemented on a single system, the communication interface 165 may communicate with the computing device 110 through a bus connection or a conductive trace.

Using the communication interface, the computing device 110 (or HWD 150, or AP 105) may coordinate operations on links 102, 185 or 125 to reduce collisions or interferences by scheduling communication. For example, the computing device 110 may coordinate communication between the computing device 110 and the HWD 150 using communication link 125. Data (e.g., a traffic stream) may flow in a direction on link 125. For example, the computing device 110 may communicate using a downlink (DL) communication to the HWD 150 and the HWD 150 may communicate using an uplink (UL) communication to the computing device 110. In some implementations, the computing device 110 may transmit a beacon frame periodically to announce/advertise a presence of a wireless link between the computing device 110 and the HWD 150 (or between HWDs 150A and 150B). In an implementation, the HWD 150 may monitor for or receive the beacon frame from the computing device 110, and can schedule communication with the HWD 150 (e.g., using the information in the beacon frame, such as an offset value) to avoid collision or interference with communication between the computing device 110 and/or HWD 150 and other devices.

In some embodiments, the processor 170 may include an image renderer, for instance, which includes an electronic component or a combination of an electronic component and a software component that generates one or more images for display, for example, according to a change in view of the space of the artificial reality. In some embodiments, the image renderer is implemented as processor 170 (or a graphical processing unit (GPU), one or more central processing unit (CPUs), or a combination of them) that executes instructions to perform various functions described herein. In other embodiments, the image renderer may be a component separate from processor 170. The image renderer may receive, through the communication interface 165, data describing an image to be rendered, and render the image through the electronic display 175. In some embodiments, the data from the computing device 110 may be encoded, and the image renderer may decode the data to generate and render the image. In one aspect, the image renderer receives the encoded image from the computing device 110, and decodes the encoded image, such that a communication bandwidth between the computing device 110 and the HWD 150 can be reduced.

In some embodiments, the image renderer receives, from the computing device, 110 additional data including object information indicating virtual objects in the artificial reality space and depth information indicating depth (or distances from the HWD 150) of the virtual objects. Accordingly, the image renderer may receive from the computing device 110 object information and/or depth information. The image renderer may also receive updated sensor measurements from the sensors 155. The process of detecting, by the HWD 150, the location and the orientation of the HWD 150 and/or the gaze direction of the user wearing the HWD 150, and generating and transmitting, by the computing device 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer may generate a small portion (e.g., 10%) of an image corresponding to an updated view within the artificial reality according to the updated sensor measurements, and append the portion to the image in the image data from the computing device 110 through reprojection. The image renderer may perform shading and/or blending on the appended edges. Hence, without recreating the image of the artificial reality according to the updated sensor measurements, the image renderer can generate the image of the artificial reality.

In other implementations, the image renderer generates one or more images through a shading process and a reprojection process when an image from the computing device 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the processor 170 (e.g., image renderer).

In some embodiments, the HWD 150 may include a lens to allow the user to see the display 175 in a close proximity. The lens may be a mechanical component that alters received light from the electronic display 175. The lens may magnify the light from the electronic display 175, and correct for optical error associated with the light. The lens may be a Fresnel lens, a convex lens, a concave lens, a filter, or any suitable optical component that alters the light from the electronic display 175. Through the lens, light from the electronic display 175 can reach the pupils, such that the user can see the image displayed by the electronic display 175, despite the close proximity of the electronic display 175 to the eyes.

In some embodiments, the processor 170 performs compensation to compensate for any distortions or aberrations. In some embodiments, a compensator may be a device separate from the processor 170. The compensator includes an electronic component or a combination of an electronic component and a software component that performs compensation. In one aspect, the lens introduces optical aberrations such as a chromatic aberration, a pin-cushion distortion, barrel distortion, etc. The compensator may determine a compensation (e.g., predistortion) to apply to the image to be rendered from the image renderer to compensate for the distortions caused by the lens, and apply the determined compensation to the image from the image renderer. The compensator may provide the predistorted image to the electronic display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a communication interface 115, a processor 118, and a content provider 130 (e.g., content provider 130A, 130B). These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view.

The processors 118, 170 includes or is embodied as one or more central processing units, graphics processing units, image processors, or any processors for generating images of the artificial reality. In some embodiments, the processors 118, 170 may configure or cause the communication interfaces 115, 165 to toggle, transition, cycle or switch between a sleep mode and a wake up mode. In the wake up mode, the processor 118 may enable the communication interface 115 and the processor 170 may enable the communication interface 165, such that the communication interfaces 115, 165 may exchange data. In the sleep mode, the processor 118 may disable the wireless interface 115 and the processor 170 may disable (e.g., may implement low power or reduced operation in) the communication interface 165, such that the communication interfaces 115, 165 may not consume power, or may reduce power consumption.

The processors 118, 170 may schedule the communication interfaces 115, 165 to switch between the sleep mode and the wake up mode periodically every frame time (e.g., 11 ms or 16 ms). For example, the communication interfaces 115, 165 may operate in the wake up mode for 2 ms of the frame time, and the communication interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced or minimized.

In some embodiments, the processors 118, 170 may configure or cause the communication interfaces 115, 165 to resume communication based on stored information indicating communication between the computing device 110 and the HWD 150. In the wake up mode, the processors 118, 170 may generate and store information (e.g., channel, timing) of the communication between the computing device 110 and the HWD 150. The processors 118, 170 may schedule the communication interfaces 115, 165 to enter a subsequent wake up mode according to timing of the previous communication indicated by the stored information. For example, the communication interfaces 115, 165 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118, 170 may configure or cause the wireless interfaces 115, 165 to enter the sleep mode. When entering the wake up mode, the processors 118, 170 may cause or configure the communication interfaces 115, 165 to resume communication via the channel or frequency band of the previous communication indicated by the stored information. Accordingly, the communication interfaces 115, in 165 entering the wake up mode from the sleep mode may resume communication, while bypassing a scan procedure to search for available channels and/or performing handshake or authentication. Bypassing the scan procedure allows extension of a duration of the communication interfaces 115, 165 operating in the sleep mode, such that the computing device 110 and the HWD 150 can reduce power consumption.

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake up mode. Accordingly, multiple computing devices 110 and HWDs 150 in proximity (e.g., within 20 ft) may coexist and operate with reduced interference.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space. The content provider 130 may encode the image data describing the image, and can transmit the encoded data to the HWD 150. In some embodiments, the content provider generates and provides the image data to the HWD 150 periodically (e.g., every 11 ms or 16 ms).

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

In some embodiments, a scheduler 118 (e.g., scheduler 118A of the computing device 118A and/or scheduler 118B of the computing device 110B) may request rTWT to transmit latency sensitive traffic using P2P communication. The AP 105 and scheduler 118 of the computing devices 110 may negotiate (e.g., perform a handshake process) and may establish a membership of a restricted TWT schedule. In some embodiments, when the AP 105 and the scheduler 118 are negotiating, the AP 105 may be considered a restricted TWT scheduling AP and the computing devices 110 may be considered a restricted TWT scheduled STA.

In some embodiments, the HWD 150 may request to send P2P traffic to the computing device 110. Accordingly, the HWD 150 may be considered the TWT requesting STA (e.g., the TWT STA that requests the TWT agreement), and the computing device 110 may be considered TWT responding STA (e.g., the TWT STA that respond to the TWT request). The communication link 125 between the computing devices 110 and the HWDs 150 may be a P2P link (e.g., a link used for transmission between two non-AP devices). The communication link 102 between the computing devices 110 and the AP 105 may be any channel or other type of link. In some configurations, the HWD 150 may move/become out of range from the access point 105. In other embodiments, the computing device 110 may request to send P2P traffic to the HWD 150 such that the computing device 110 is considered the TWT requesting STA and the HWD 150 is the TWT responding STA.

The schedulers 118 of the computing devices 110 may schedule communication between the computing device(s) 110 and the HWD(s) 150 with the AP 105 such that the communication between the computing device(s) 110 and HWD(s) 150 is protected. The computing device(s) 110 may initiate such protected P2P communication with the HWD(s) 150 by indicating, to the AP 105, that the computing device(s) 110 wish to schedule P2P communication in rTWT service periods (SPs). The scheduler 118 of the computing device(s) may schedule (or negotiate) the requested rTWT SP(s). The scheduler 118 of the computing device(s) may also indicate if the SP(s) are requested only for P2P communication (as compared to mixed P2P communication and non-P2P communication).

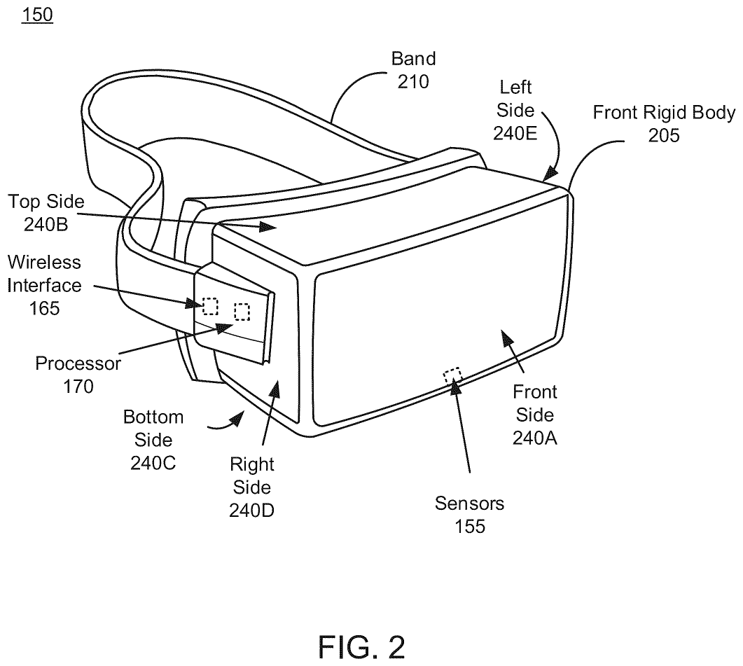

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not be visible to the user. In other embodiments, the HWD 150 has a different configuration than shown in FIG. 2. For example, the processor 170, the eye trackers, and/or the sensors 155 may be in different locations than shown in FIG. 2.

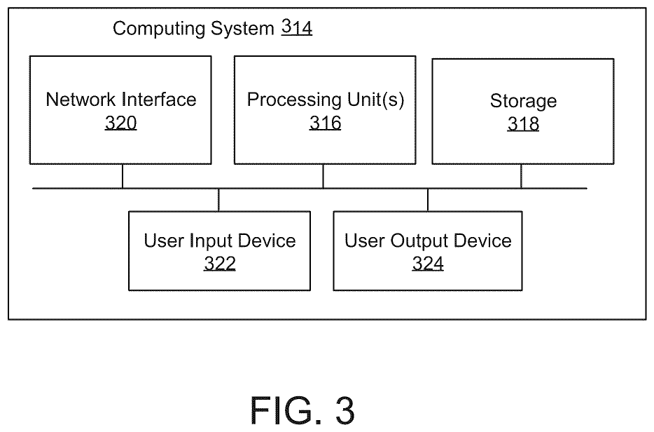

Various operations described herein can be implemented on computer systems. FIG. 3 shows a block diagram of a representative computing system 314 usable to implement the present disclosure. In some embodiments, the computing device 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

FIGS. 1-3 illustrate devices that communicate traffic streams between various devices of a service set to an access point. Depending on the devices and applications which are supported thereby, certain traffic may have different quality of service (QoS) characteristics. Additionally, in various implementations, various access points may be located in a common or neighboring environment.

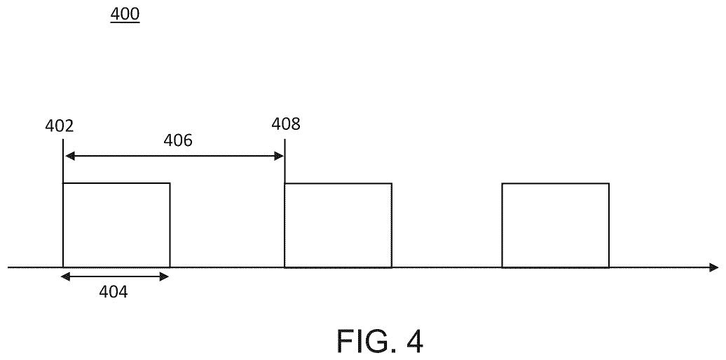

Referring generally to FIG. 4-FIG. 11, the systems and methods described herein may share QoS characteristics among access points, for scheduling/coordinating/managing respective schedules for the corresponding service sets. An AR/VR context or environment may include various devices which communicate with one another over a network. Such devices can include stations (STAs), and access points (APs), including a mobile AP (“hotspot”), Wi-Fi direct group owner (GO), or a device configured to alternatively operate as an AP and/or an STA at a given instance. Some devices may operate on a schedule, and can enter into a sleep state to reduce energy usage and thermal loads. For example, the operating time of a head mounted device (HMD) may be limited by a battery life or a thermal constraint, such that the HMD can opportunistically enter a sleep state (at least for a transceiver) to reduce energy usage and thermal loads. However, managing network latency along with sleep states can prove challenging. Latency sensitive traffic that is not prioritized (or protected) may degrade a user experience. For example, in an AR/VR context, latency between a movement of a user wearing an HMD or related device and an image corresponding to the user movement and displayed to the user using the HMD device may cause judder, resulting in motion sickness.

A Target Wake Time (TWT) is a mechanism where a set of service periods (SPs) are defined and shared between devices to reduce medium contention and improve the power efficiency of network devices. The TWT reduces energy consumption of the devices by limiting the awake time and associated power consumption of the devices. For example, the first device can wake up periodically based on the TWT. During the SP, a device may be in an awake state (e.g., its wireless communication module/interface is in a fully powered-up, ready, or wake state) and is able to transmit and/or receive. Outside of the SP, the device the device may not remain awake (e.g., its wireless communication module/interface is in a powered-down, low power, or sleep state), which may reduce a power use or a thermal load of the first device. In addition to or instead of the sleep state, a device can communicate with other devices or on other networks.

The TWT can be agreed/negotiated upon by devices (e.g., access points (APs) and/or stations (STAs)), and/or specified/configured by one device (e.g., an AP). For example, each SP can be established on a peer to peer basis as individual TWT (iTWT), or on an 1-to-n basis as broadcast TWT (bTWT), between a TWT scheduling devices and one or more TWT scheduled devices. In some embodiments, TWTs may further be communicated between adjacent basic service sets (BSS) to avoid medium contention. Scheduling between or within BSS, can avoid contention and reduce latency, such as latency of virtual objects included in video frames transmitted from a computing device to a head mounted device (HMD). Some TWT may be established as a restricted TWT (R-TWT). The SP of a R-TWT may be intended or limited for certain traffic identifiers, such as identifiers for latency sensitive traffic (e.g., video data).

Streams of traffic may be characterized by different types of traffic, which may correspond to respective QoS characteristics for the traffic. For instance, an application may be characterized by latency sensitive traffic (e.g., video/voice (VI/VO), real time interactive applications, and the like) or regular traffic (e.g., best effort/background applications (BE/BK)). Latency sensitive traffic may be identifiable, in part, based on its bursty nature (e.g., periodic bursts of traffic), in some embodiments. For instance, video display traffic may be driven by a refresh rate of 60 Hz, 72 Hz, 90 Hz, or 120 Hz, where bursts of frame data appear at regular interval (e.g., every 13.888 . . . ms at 72 Hz). An application and/or device may have combinations of traffic types (e.g., latency sensitive traffic and non-latency sensitive traffic). Further, each stream of traffic for the application and/or device may be more or less spontaneous and/or aperiodic as compared to the other streams of traffic for the application and/or device. Accordingly, traffic may vary according to applications and/or channel rate dynamics, which correspondingly requires different QoS characteristics for supporting the respective traffic.

Each access point may support a different service set (SS) (or basic service set (BSS)) with corresponding STAs, which correspondingly may have its own TWT schedule and QoS characteristics for traffic exchanged by STAs. Where two access points are located nearby one another, such access points may benefit from coordination. According to the present disclosure, an access point may share traffic characteristics-such as QoS characteristics-with other (e.g., neighboring, nearby) access point(s), to facilitate coordination between the access points. Such coordination may include TWT schedule coordination, TXOP sharing, spatial reuse, and/or triggered access operations. The systems and methods described herein may configure a QoS characteristics element to facilitate its usage for exchanging QoS information/characteristics of traffic for a service set of an AP with another AP. The QoS characteristics element may be carried in, for example, an action or management frame, a stream classification service (SCS) request or response frame, and/or an individually addressed frame. The systems and methods described herein may use the QoS characteristics element for coordination.

FIG. 4 is a timing diagram 400 showing a wake-up/sleep schedule of a computing device utilizing TWT, according to an example implementation of the present disclosure. The TWT start time is indicated by the computing device 110 (e.g., a portion of its relevant modules/circuitry) waking up at 402. The computing device 110 may wake up for a duration 404 defined by a SP. After the SP duration 404, the computing device 110 may enter a sleep state until the next TWT start time at 408. The interval of time between TWT start time 402 and TWT start time 408 may be considered the SP interval 406. The communication and/or negotiation of the duration 404 between devices can lower energy use (e.g., wherein a device can enter a sleep state between durations 404), and improve latency/network congestion (e.g., by scheduling restricted time periods for particular latency sensitive data).

A TWT schedule may be communicated and/or negotiated using broadcast TWT (bTWT) and/or individual TWT (iTWT) signaling. In some embodiments, the TWT schedule for an iTWT can specify the SP interval 406 according to an integer number of microseconds. In some embodiments, the TWT schedule for a bTWT can specify the SP interval 406 according to an integer number of time units (TU), each consisting of 1024 microseconds (μs). TWT schedule information may be communicated to particular (individual) devices using a mode such as a Network Allocation Vector (NAV) to protect the medium access of TWT SPs. In contrast, to signal bTWT, in some embodiments, a device (such as AP 105) may schedule TWT SPs with other devices (e.g., computing devices 110 and/or HWDs 150) and may share schedule information in beacon frames and/or probe response frames. Sharing schedule information using bTWT may reduce overhead (e.g., negotiation overhead) as compared to the overhead used when sharing information using iTWT.

The TWT mechanism may also be used in peer-to-peer (P2P) communication. For example, TWT may be defined for tunneled direct link setup (TDLS) pairs (e.g., non-AP STAs), soft APs (such as computing devices 110) and STAs (such as HWD 150), and/or peer-to-peer group owners (GO) and group clients (GC). For instance, a TDLS pair of devices (e.g., HWD 150 and computing device 110) can request TWT membership for its latency sensitive traffic over a channel. In another example, a group owner (GO), such as a computing device 110, may request TWT membership for latency sensitive traffic over the P2P link.

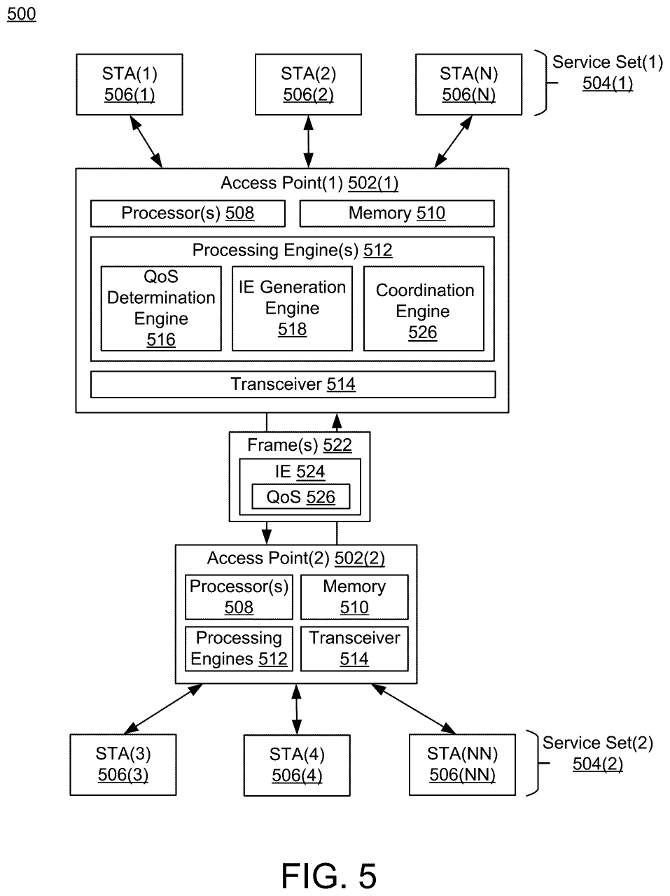

Referring now to FIG. 5, depicted is a block diagram of a system 500 for sharing quality of service (QoS) characteristics, according to an example implementation of the present disclosure. The system 500 may include a first access point (AP) 502(1) and a second AP 502(2) (referred to generally as AP 502). Each AP 502 may provide a local area network (LAN), such as a wireless-LAN (WLAN), to a service set (SS) 504 including one or more stations (STAs) 506. As described in greater detail below, an AP 502 may be configured to generate an information element (IE) 524 indicating QoS characteristics of the SS 504 for the AP 502. The AP 502 may be configured to transmit the IE 524 to another AP 502. The APs 502 may be configured to exchange IEs 524 corresponding to QoS characteristics for their respective SSs 504, to coordinate various schedules for the respective networks.

As shown in FIG. 5, the system 500 may include various APs 502 and STAs 506. The APs 506 may be the same as or similar to the AP 105 described above with reference to FIG. 1. Similarly, the STAs 506 may be similar to the devices 110, 150 described above with reference to FIG. 1. The APs 502 may include respective processor(s) 508, memory 510, and transceivers 512. The processor(s) 508 may be similar to processor(s) 118 and or processing unit(s) 316, the memory 510 may be similar to the storage 318, and the transceivers 512 may be similar to the communication interface 115 and/or network interface 320, each described above with reference to FIG. 1-FIG. 3. While shown as being included on the APs 502, it is noted that the STAs 506 may include similar hardware deployed/provided thereon.

The APs 502 may include one or more processing engines 514. The processing engine(s) 514 may be or include any device, component, element, or hardware designed or configured to perform various functions of the AP 502. For example, the processing engine(s) 514 may be or include processor(s) 508 which execute various instructions stored on memory 510 to perform respective functions. The processing engine(s) 514 may include a QoS determination engine 516, an IE generation engine 518, and a coordination engine 520. While these processing engine(s) 514 are shown and described, it is noted that the APs 502 may include additional, fewer, and/or alternative processing engine(s) 514. Further, two or more processing engine(s) 514 may be combined into a single processing engine 514, and/or a processing engine 514 may be divided into multiple processing engines 514.

The APs 502 may include a QoS determination engine 516. The QoS determination engine 516 may be designed or configured to detect, identify, or otherwise determine QoS characteristics of traffic for the SS 504. In some embodiments, the QoS determination engine 516 may be configured to determine QoS characteristics based on signals/information/frames received from the STAs 506 of the SS 504. For example, the QoS determination engine 516 may be configured to receive WLAN multimedia (WMM) frames which indicate or otherwise identifies traffic type which the STA 506 is sending to the AP 502 (or receiving from the AP 502). The WMM frames may categorize traffic into, for example, voice traffic, video traffic, best effort traffic, and/or background traffic. The QoS determination engine 516 may be configured to determine, detect, or otherwise identify QoS capabilities of the STAs 506, which the STAs 506 may communicate to the AP 502 during an association/registration/handshake process. The QoS determination engine 516 may be configured to select, determine, or otherwise configure various QoS parameters/configurations/characteristics for the network based on the information included in the WMM frames and/or QoS capabilities.

The QoS determination engine 516 may be configured to determine several different QoS characteristics for the network. The QoS characteristics may include, for example, a minimum service interval, a maximum service interval, a delay bound, a service start time, and a medium time. Additionally, the QoS determination engine 516 may be configured to determine various other information relating to the SS 504 and/or network. Such other information may include, for example, a SS identifier (SSID, or BSSID), a schedule identifier (ID), and/or a bandwidth which is to be used for supporting the network.

The QoS determination engine 516 may be configured to determine the QoS characteristics per traffic identifier (TID). For example, each type of traffic (e.g., indicated in the WMM frame) may include a corresponding TID. The TID may indicate a traffic type for different classifications of traffic (e.g., voice traffic, video traffic, best effort traffic, and/or background traffic). The QoS determination engine 516 may be configured to determine the QoS characteristics for each TID, where the QoS characteristics may be the same or different across TIDs. The minimum service interval and maximum service interval may include, indicate, or otherwise identify the service intervals which are to be used to service the traffic (e.g., of the TIDs). In various embodiments, the service intervals may be set based on the traffic type. For example, the service intervals may be set to be the same value for periodic traffic. The service start time may indicate or identify a time (e.g., in the future) where the first service interval or service period is scheduled to commence/start.

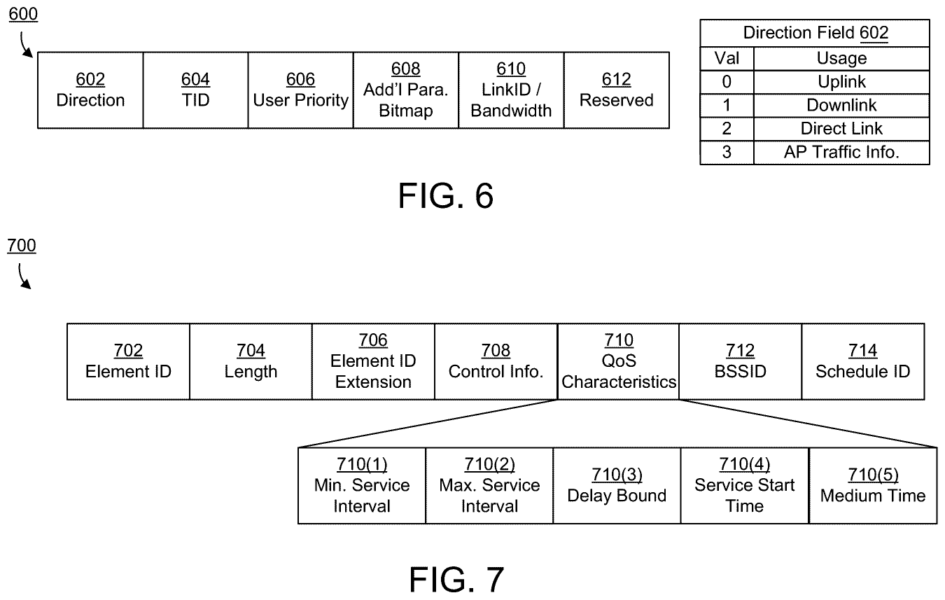

Referring to FIG. 5 and FIG. 6-FIG. 10, the APs 502 may include an information element (IE) generation engine 518. Specifically, FIG. 6-FIG. 10 depict various examples of frames 522 which may carry, incorporate, or otherwise include an IE 524 generated by the IE generation engine 518. As described in greater detail below, the IE 524 may include, indicate, or otherwise identify various QoS characteristics 526 of traffic for the SS 504 (e.g., determined by the QoS determination engine 516). Different formats for IEs 524, and the types of QoS characteristics 526 shared therein, are described in greater detail below. The IE generation engine 518 may be configured to compile, create, produce, populate, or otherwise generate the IE 524, including various QoS characteristics 526, for transmitting, sending, or otherwise providing in a frame 522 to another AP 502.

It is noted that, while certain fields and sub-fields are used to refer to certain portions of IEs 524, it is noted that these terms can be used interchangeably. For example, a field as described with reference to an IE 524 may include various sub-fields, and a sub-field may additionally or alternatively be defined as a field in of itself. Furthermore, the order and/or arrangement of fields/sub-fields shown in the IE 524 are not intended to be limiting. Rather, the fields and sub-fields may be arranged in different orders. Additionally, various example IEs 524 may include further fields or sub-fields in addition to those shown and described herein.

Each field or sub-field may be populated with certain bits or bit flags to indicate corresponding information in the field. While certain example bits or bit flags are provided herein, it is noted that the present disclosure is not limited to those examples. For example, where a field is described as having a value of “1” to indicate a positive status of the field, the field may alternatively have a value of “0” to indicate the positive status. Similarly, while certain fields may have acceptable values to indicate the corresponding status/information of the field, other acceptable values may be provided with corresponding status/information.

Referring specifically to FIG. 6, depicted is an example format 600 of various control information fields of an information element 524 that may be used to convey, indicate, or otherwise identify QoS information of a SS 504 for a first AP 502 with a second AP 502. In the example shown in FIG. 6, the control information field format 600 may be or include control fields for QoS characteristics information element 524. The control fields may include a direction field 602, a TID field 604, a user priority field 606, an additional parameters bitmap field 608, a linkID/bandwidth field 610, and/or a reserved field 612.

The direction field 602 may be used to indicate, designate, denote, or otherwise identify a directionality relating to the information shared in the element 600. As shown in FIG. 6, the direction field 602 may include acceptable values which correspond to particular usages. For example, the direction field 602 may include a first value (e.g., “0”) indicating that the usage of the element 600 is for uplink (e.g., MAC service data units (MSDUs) or aggregated MSDUs (A-MSDUs) are sent from a non-AP STA 506 to the AP 502), a second value (e.g., “1”) indicating that the usage of the element 600 is for downlink (e.g., MSDUs or A-MSDUs are sent from the AP 502 to a non-AP STA 506), a third value (e.g., “2”) indicating that the usage of the element 600 is for direct link (e.g., MSDUs or A-MSDUs are sent over a peer-to-peer link), and a fourth value (e.g., “3”) indicating that the usage of the element 600 is for AP traffic information (e.g., MSDUs or A-MSDUs are sent from one AP 502 to another AP 502 indicating traffic information of the SS 504 for the AP 502).

As mentioned above, the TID field 604 may indicate, designate, denote, or otherwise identify traffic identifiers (TIDs) of traffic/traffic types for the SS 504. The user priority field 606 may indicate, designate, denote, or otherwise identify a priority which corresponds to the traffic type. In some embodiments, for the element 600, the TID field 604 and user priority field 606 may identify the highest TID of traffic that the transmitting AP 502 may deliver or receive during the service period. The additional parameters bitmap field 606 may include a bitmap which denotes/identifies a presence (e.g., identified by a value of “1” in the bitmap) or absence (e.g., identified by a value of “0” in the bitmap) of certain additional QoS parameters that may be available for indication in the QoS element 600 (e.g., those available to be included in the QoS characteristics field 710 of FIG. 7, described below).

The linkID/bandwidth field 610 may indicate, designate, denote, or otherwise identify at least one of a linkID or a bandwidth used by the AP 502. The linkID may be or include an identifier which is associated with or corresponding to a particular link between the device which is transmitting the element 600 and its intended recipient. For example, where the device which is transmitting the element 600 is a STA 506 and the recipient is an AP 502 (or vice versa, or two devices in a peer-to-peer direct connection), as indicated by the value of the direction field 602, the value provided to the linkID field 610 may indicate or denote the identifier corresponding to the link between the STA 506 and AP 502. The bandwidth may be or include a bandwidth requirement/configuration for an AP 502 for delivering traffic during the indicated/identified service period/intervals. The bandwidth may be identified using values ranging from 0-7, for example, where 0 indicates a 20 MHz bandwidth, 1 indicates a 40 MHz bandwidth, 2 indicates an 80 MHz bandwidth, 3 indicates a 160 MHz bandwidth, 4 indicates a 320 MHz bandwidth, and so forth.

In some embodiments, the linkID/bandwidth field 610 may identify the linkID or the bandwidth, depending on the value provided to the direction field 602. For example, where the direction field 602 includes a value indicating that the usage is for uplink, downlink, or direct link, the field 610 may include a value which corresponds to the linkID. Where the direction field 602 includes a value indicating that the usage is for AP traffic information, the field 610 may include a value which corresponds to the bandwidth. In this regard, the field 610 may identify different types of information (e.g., the linkID and/or bandwidth), depending on the value provided in the direction field 602.

The element 600 may include a reserved field 612 for various additional information which may be useful for sharing other control information, QoS information, and the like.

Referring now to FIG. 7, depicted is an example format 700 of various characteristics information fields of an information element 524 that conveys, indicates, or otherwise identifies specific QoS information of a SS 504 for a first AP 502 with a second AP 502. In this regard, the characteristics fields may carry additional information relating to QoS characteristics. In some embodiments, the characteristics information fields may follow the control information fields shown in FIG. 6 and described above. The characteristics information fields may include an element ID field 702, a length field 704, an element ID extension field 706, a control information field 708, a QoS characteristics field 710, a BSSID field 712, and a schedule ID field 714.

The element ID field 702 to identify the element as QoS characteristics information element 524. For example, a predefined bit pattern can identify the frame type relative to other management frames. the length field 704 can provide a length of the further portions of the information element 524 (e.g., exclusive and/or inclusive of the element ID 702 and/or length field 704, and/or the control information included in the fields of FIG. 6). The element ID extension field 706 can include an extension to the octet of the element ID field 702 to further specify the contents of the IE 524. The control field 708 may include or contain subfields that define the frame type (management, control, or data), the specific subtype (such as beacon, probe request, or association request), protocol version, and other control flags like retry, power management, and more. The QoS characteristics field 710 may include various sub-fields, described in greater detail below, which indicate, specify, designate, denote, or otherwise identify QoS characteristics 526. The BSSID field 712 may indicate, denote, or otherwise identify an identifier associated with the SS 504. The BSSID field 712 may be or include a six octet field (or smaller field) indicating at least a portion of the basic SS identifier (BSSID) used by the transmitting AP 502. The schedule identifier field 714 identify, denote, or otherwise indicate an identifier which the receiving device can use to link the IE 524 to a particular schedule (e.g., TWT schedule), resource reservation or scheduling negotiation (e.g., TXOP, sharing, spatial reuse) in signaling with other frames/elements shared between the transmitting device and receiving device (e.g., APs 502).

Returning to the QoS characteristics field 710, the QoS characteristics field 710 may include a plurality of sub-fields used to indicate, denote, provide, or otherwise identify various QoS characteristics of the BSS. The sub-fields provided in the QoS characteristics field 710 may be indicated or identified by the additional parameters bitmap 608 described above. The sub-fields may include a minimum service interval sub-field 710(1), a maximum service interval sub-field 710(2), a delay bound sub-field 710(3), a service start time sub-field 710(4), and a medium time sub-field 710(5). While these sub-fields 710 are shown and described, it is noted that additional sub-fields 710 may be included in the QoS characteristics field 710. For example, where the direction field 602 indicates that the IE 524 is for uplink, downlink, or direct link usage, the QoS characteristics field 710 may include additional sub-fields, such as a minimum data rate sub-field, a maximum MSDU size sub-field, a service start time linkID sub-field, a mean data rate sub-field, a delay bounded burst size sub-field, an MSDU lifetime subfield, and/or a MSDU delivery information sub-field. Inclusion or exclusion of these and other sub-fields may be denoted or indicated by the bitmap included in the additional parameters bitmap field 608.

The minimum service interval sub-field 710(1) and maximum service interval sub-field 710(2) may indicate, specify, or otherwise identify the minimum and maximum intervals that the transmitting AP 502 is to use for delivering its traffic (e.g., to STAs 506 of the SS 504). In some embodiments, for periodic traffic, the minimum and maximum interval may be set to be the same value. The delay bound sub-field 710(3) may indicate, specify, or otherwise identify the delay bound, or a limit on an amount of time that packets or frames are permitted to take to travel from a source device to a destination device (e.g., from the AP 502 to a particular STA 506, or vice versa). The service start time sub-field 710(4) may indicate, specify, or otherwise identify a time (e.g., start time) where a first service interval for the SS 504 is to commence. The medium time sub-field 710(5) may indicate, specify, or otherwise identify the medium which is to be used for delivering the traffic (e.g., on which channel of the width specified in the bandwidth identified in linkID/bandwidth field 610).

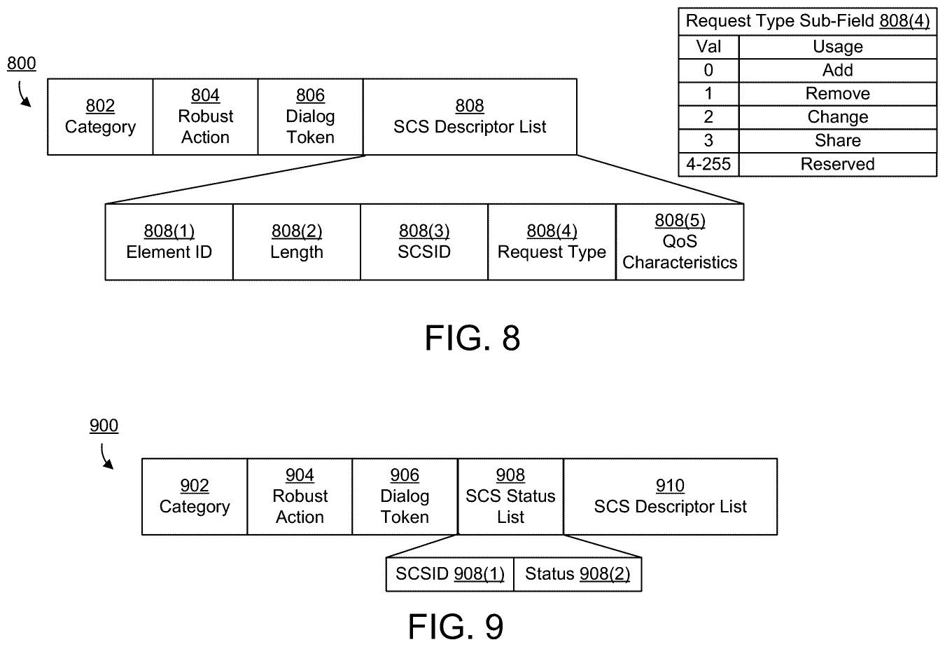

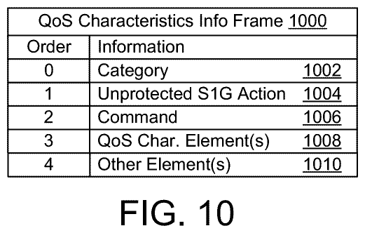

As described above, the IE generation engine 518 may be configured to populate the IE 524 with the QoS characteristics 526. In some embodiments, as shown in FIG. 6 and FIG. 7, the IE generation engine 518 may be configured to incorporate or include the IE 524 in a management or action frame 522. For example, the frame 522 may carry additional information relating to a schedule, such as a TWT element, or any other element 524 which carries TWT schedule information. In some embodiments, the IE generation engine 518 may be configured to incorporate or include the IE 524 (or information identified/included in the IE 524) in a spatial consistency sounding (SCS) frame 522 (e.g., an SCS request or response frame), as described with reference to FIG. 8 and FIG. 9. In some embodiments, the IE generation engine 518 may be configured to incorporate or include the IE 524 (or information identified/included in the IE 524) in an individually-addressed frame 522, as described with reference to FIG. 10.

Referring now to FIG. 8 and FIG. 9, depicted are example frames 522 which can be used to identify or otherwise indicate QoS characteristics, according to an example implementation of the present disclosure. Specifically, FIG. 8 is an example of a SCS request frame 800, and FIG. 9 is an example of an SCS response frame 900. As shown in FIG. 8 and FIG. 9, the SCS request frame 800 and SCS response frame 900 may include respective category fields 802, 902, respective robust action fields 804, 904, respective dialog token fields 806, 906, and/or respective SCS descriptor list fields 808, 910. In addition, the SCS response frame 900 may include an SCS status list field 908.

The category fields 802, 902 may indicate, denote, or otherwise identify a specific category or class of an action which is being requested or responded to. The robust action fields 804, 904 may indicate, denote, or otherwise identify whether the action identified by the category field 802, 902 is to have reliable delivery (e.g., actions which pertain to features that enhance performance or efficiency, such as QoS management, power saving, coordination, and so forth). The dialog token fields 806, 906 may indicate, denote, or otherwise identify an identifier or token which associates a request with a corresponding response (e.g., matching an SCS request frame with a corresponding SCS response frame), or otherwise tracking transactions between transmitting and receiving devices.

Various sub-fields may be included or incorporated into the SCS descriptor list field 808, 910. For example, the SCS descriptor list field 808, 910 may include an element identifier sub-field 810(1), a length sub-field 810(2), an SCSID sub-field 810(3), a request type sub-field 810(4), and/or a QoS characteristics sub-field 810(5). The element identifier sub-field 810(1) and length sub-field 810(2) may be similar to the element identifier field 702 and length field 704 described above with reference to FIG. 7. The SCSID sub-field 810(3) may indicate or identify an identifier corresponding to the SCS session or measurement, for distinguishing between different SCS operations. The request type sub-field 810(4) may indicate a type of request corresponding to an action which is to be performed via the SCS request/response frame 522. As shown in FIG. 8, the request type sub-field 810(4) may include values for indicating different usages of the SCS request/response frame. For example, the request type sub-field 810(4) may have a first value (e.g., “0”) which indicates that the usage is to add a new element or configuration for a network, a second value (e.g., “1”) which indicates that the usage is to remove an existing element or configuration for a network, a third value (e.g., “2”) which indicates that the usage is to change an existing element or configuration for a network, and a fourth value (e.g., “3”) which indicates that the usage is to share QoS characteristics between different networks by different APs 502. The QoS characteristics sub-field 804(5) may include various sub-fields corresponding to QoS characteristics similar to those described above with reference to FIG. 6 and FIG. 7.

With reference to FIG. 9, the SCS response frame may include an SCS status list field 908 with sub-fields that indicate, for each SCS, a SCSID 908(1) and a corresponding status 908(2). The SCSID 908(1) may be populated with a value from the SCSID sub-field 810(3) of a SCS request frame from a transmitting AP 502. The status sub-field 908(2) may include a value indicating a status of the SCS request frame. The status may include, for example, accepted, rejected, rejected with suggested changes, and acknowledge QoS characteristics statuses. The IE generation engine 518 of a recipient AP 502 (e.g., which receives an SCS request frame from a transmitting AP 502) may be configured to populate the status sub-field 908(2) to, for example, a value to indicate an acceptance where the recipient AP 502 agrees to assist the transmitting AP 502 in delivering the indicated traffic (e.g., by setting up coordinated TWT schedules (e.g., R-TWT), via enhanced TXOP sharing or via enhanced spatial reuse or any other mechanism). The IE generation engine 518 may be configured to populate the status sub-field 908(2) with a value to indicate a rejection where the proposal sent by the transmitting AP is not accepted, or with a value to indicate rejection with suggested changes to indicate that the proposal is not acceptable but would be if the request were made with suggested changes The exchange between the two APs 502, resulting in “ACCEPTED” SCS Response frame, may be defined as a QoS coordination agreement.

With reference to FIG. 10, in some embodiments, the frame 522 may be or include an individually addressed frame 1000 including fields 1002-1010 for providing various QoS characteristics similar to those described above. For example, the individually addressed frame 1000 may be or include a QoS characteristics information frame including a first field 1002 for providing a category of the frame (e.g., an action field), a second field 1004 for providing or indicating an unprotected SIG action set to TWT schedule coordination, a third field 1006 for providing a command indicating the action expected by the receiving AP 502 (e.g., similar to the request type sub-field 808(4) described above), a fourth field 1008 for providing one or more QoS characteristics elements similar to those described above with reference to FIG. 6-FIG. 9, and a fifth field 1010 for providing additional or alternative elements (such as reserved fields, command or control fields, etc.).

Referring back to FIG. 5, the coordination engine 520 may be configured to coordinate TWT schedules based on or according to the frames 522 exchanged between the APs 502. For example, the coordination engine 520 of the first AP 502(1) may be configured to transmit the frame 522 (e.g., via the transceiver 512) to the second AP 502(2). The frame 522 may be a management or action frame, an SCS request frame, etc. The coordination engine 520 of the second AP 502(2) may be configured to receive and process the frame 522. The IE generation engine 518 of the second AP 502(2) may be configured to generate an IE 524 for including in a response to the frame 522 from the first AP 502(1) (e.g., in a response to the management or action frame, in an SCS response frame, etc.). The coordination engine 520 of the second AP 502(2) may be configured to transmit the response frame to the first AP 502(1).

In some embodiments, the coordination engines 520 of the respective APs 502 may be configured to establish a coordinated TWT schedule according to the respective frames. For example, the coordination engines 520 may be configured to establish a reserved TWT (R-TWT) schedule, a transmission opportunity (TXOP) schedule, a spatial reuse coordination, etc., according to the QoS characteristics of the respective SS 504 for the corresponding APs 502.

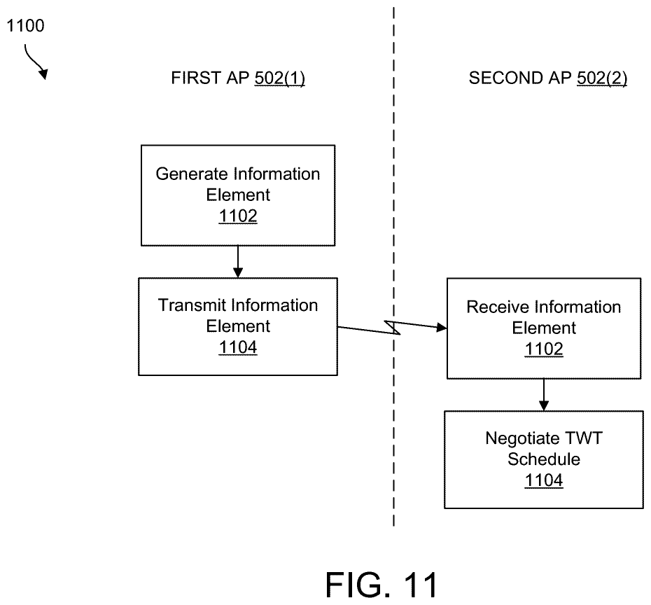

Referring now to FIG. 11, depicted is a flowchart showing an example method 1100 for sharing quality of service (QoS) characteristics, according to an example implementation of the present disclosure. The method 1100 may be performed by the devices, components, elements, or hardware described above with reference to FIG. 1-FIG. 10, such as the first AP 502(1) and/or the second AP 502(2). In some embodiments, some steps/operations/acts of the method 1100 may be performed by one of the first AP 502(1) or the second AP 502(2), and other steps/operations/acts may be performed by the other one of the first AP 502(1) or the second AP 502(2). As a brief overview, at step 1102, a first AP may generate an information element. At step 1104, the first AP may transmit the information element. At step 1106, a second AP may receive the information element. At step 1108, the second AP may negotiate a TWT schedule.

At 1102, a first AP may generate an information element. In some embodiments, the first AP may generate the information element indicating quality of service (QoS) characteristics of a service set (SS) for the first AP. The first AP may generate the information element responsive to establishing the SS for the first AP. For example, the first AP may generate the information element following one or more stations (STAs) establishing a connection with the first AP and/or otherwise associating with the first AP. The first AP may generate the information element responsive to detecting, determining a presence of, or otherwise identifying a neighboring/nearby second AP. The first AP may generate the information element for transmission to the second AP.

In some embodiments, the first AP may generate the information element as part of or in connection with generating a management frame, an action frame, a spatial consistency sounding (SCS) request frame, an SCS response frame, or an individually addressed frame. In other words, and in some embodiments, the information element may be carried in a management or action frame, an SCS request/response frame, or any frame. The frames may have a format similar to the formats described above with reference to FIG. 6-FIG. 10. As described above, the information element may include a control information field including a subfield (e.g., field 602 of FIG. 6) indicating a direction of the information element. The subfield may be set (e.g., to a value) which indicates that the information element is carrying QoS characteristics for the SS of the first AP. For example, as shown in FIG. 6, the subfield may be set to a value (e.g., “3”) to indicate that the information element is carrying AP traffic information (e.g., QoS characteristics).

In some embodiments, the control information field further includes another subfield identifying at least one of a link identifier or a bandwidth (e.g., field 610 of FIG. 6). The subfield may identify different values from among the link identifier or bandwidth, based on values provided in other subfields. For example, where the direction subfield is set to a value which indicates that the information element is carrying QoS characteristics, the subfield may identify a bandwidth. On the other hand, where the direction subfield is set to a value which indicates that that information element is for, e.g., uplink, downlink, or direct link usage, the subfield may identify a link identifier.

The information element may include QoS characteristics of the service set. For example, the QoS characteristics may include, identify, or otherwise indicate traffic characteristics during respective service intervals identified in the information element. The QoS characteristics may include a minimum service interval, a maximum service interval, a delay bound, a service start time, and/or a medium time. The information element may include various other information for identifying the information element. For example, the information element may include a field for indicating an identifier for the service set (e.g., a BSSID) and/or a schedule identifier.

At 1104, the first AP may transmit the information element. In some embodiments, the first AP may transmit the information element to a second AP. In some embodiments, the first AP may transmit the information element by broadcasting the information element to any neighboring second APs. In some embodiments, the first AP may transmit the information element by transmitting the information element directly to the second AP. The first AP may transmit the information element to the second AP as part of negotiating (or coordinating) a TWT schedule, or otherwise informing the second AP of the QoS characteristics for resource allocation/interference mitigation. At step 1106, the second AP may receive the information element. The second AP may receive the information element from the first AP, responsive to the first AP transmitting the information element.

At 1108, the second AP may negotiate a TWT schedule (e.g., with the first AP). In some embodiments, the second AP may negotiate a TWT schedule based on reception and analysis of the information element (e.g., received at step 1106). For example, the second AP may generate an additional information element which indicates QoS characteristics of the SS for the second AP, and transmit the additional information element to the first AP. The second AP may transmit the additional information element in a response to the management frame or action frame, in a SCS response frame, or any other frame. The second AP may generate the additional information element to include the QoS characteristics of the SS of the second AP, and a status of the information element sent by the first AP (e.g., acceptance, rejection, rejection with suggested changes, QoS characteristics acknowledgement). The first AP may receive the additional information element from the second AP. The first AP and the second AP may establish a coordinated target wake time (TWT) schedule according to the respective information elements.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
generating, by a first access point (AP), an information element indicating quality of service (QoS) characteristics of a service set (SS) for the first AP; and
transmitting, by the first AP, the information element to a second AP.

2. The method of claim 1, wherein the information element includes a control information field including a first subfield indicating a direction of the information element, wherein the first subfield is set to indicate that the information element is carrying the QoS characteristics of the SS.

3. The method of claim 2, wherein the control information field further includes a second subfield identifying at least one of a link identifier or a bandwidth.

4. The method of claim 3, wherein the second subfield identifies the link identifier when the first subfield is set to a first value, and the second subfield identifies the bandwidth when the first subfield is set to a value other than the first value.

5. The method of claim 1, wherein the QoS characteristics indicate traffic characteristics during respective service intervals identified in the information element.

6. The method of claim 1, wherein the QoS characteristics comprise a minimum service interval, a maximum service interval, a delay bound, a service start time, and a medium time.

7. The method of claim 1, wherein the information element further comprises a field indicating an identifier for the service set and a schedule identifier.

8. The method of claim 1, wherein the information element comprises a first information element, the method further comprising:
receiving, by the first AP from the second AP, a second information element indicating QoS characteristics of a second SS for the second AP.

9. The method of claim 8, further comprising:
establishing, by the first AP with the second AP, a coordinated target wake time (TWT) schedule according to the first information element and the second information element.

10. The method of claim 1, wherein the information element is carried in at least one of a management or action frame, a spatial consistency sounding (SCS) request frame, an SCS response frame, or an individually addressed frame.

11. A first access point (AP), comprising:
a transceiver; and
one or more processors configured to:
generate an information element indicating quality of service (QoS) characteristics of a service set (SS) for the first AP; and
transmit, via the transceiver, the information element to a second AP.

12. The first AP of claim 11, wherein the information element includes a control information field including a first subfield indicating a direction of the information element, wherein the first subfield is set to indicate that the information element is carrying the QoS characteristics of the SS.

13. The first AP of claim 12, wherein the control information field further includes a second subfield identifying at least one of a link identifier or a bandwidth, and
wherein the second subfield identifies the link identifier when the first subfield is set to a first value, and the second subfield identifies the bandwidth when the first subfield is set to a value other than the first value.

14. The first AP of claim 11, wherein the QoS characteristics indicate traffic characteristics during respective service intervals identified in the information element.

15. The first AP of claim 11, wherein the QoS characteristics comprise a minimum service interval, a maximum service interval, a delay bound, a service start time, and a medium time.

16. The first AP of claim 11, wherein the information element further comprises a field indicating an identifier for the service set and a schedule identifier.

17. The first AP of claim 11, wherein the information element comprises a first information element, and wherein the one or more processors are further configured to:
receive, via the transceiver from the second AP, a second information element indicating QoS characteristics of a second SS for the second AP; and
establish, with the second AP, a coordinated target wake time (TWT) schedule according to the first information element and the second information element.

18. The first AP of claim 11, wherein the information element is carried in at least one of a management or action frame, a spatial consistency sounding (SCS) request frame, an SCS response frame, or an individually addressed frame.

19. The first AP of claim 11, wherein the first AP comprises at least one of a hardware AP, a soft AP, or a peer-to-peer station (STA).

20. A non-transitory computer readable medium storing instructions that, when executed by one or more processors of a first access point (AP), cause the one or more processors to:
generate an information element indicating quality of service (QoS) characteristics of a service set (SS) for the first AP; and
transmit, via a transceiver, the information element to a second AP.
